(19) United States
(12) Patent Application Publication
(10) Pub. No.: US 2003/0190222 A1
(43) Pub. Date: Oct. 9, 2003

(54) Back bone beam dolly

(76) Inventor: Steven Ross Riggin, Pittsburg, KS (US)

Correspondence Address: Steven Ross Riggin, Rt. 5, P.O. Box 211, Girard, KS, 66743, US

(21) Appl. No.: 10/053,896

(22) Filed: Apr. 8, 2002

(51) Int. Cl. B60P 1/00

(52) U.S. Cl. 414/540

(57) ABSTRACT

This invention deals with a multipurpose material-handling device. It is possible to quickly modify the backbone beam dolly to perform a variety of material-handling tasks.

In its most basic version the backbone beam dolly is equipped with a pair of non-swivel wheels forming a wheel assembly at one end and a pair of swivel wheels at the other end.

Four-wheel dollies can also be used to replace the wheel assemblies. A crane beam can be rigidly affixed to the backbone beam dolly. With the addition of the crane beam and outrigger it is possible to pick-up heavy loads safely and transport them over vast distances by manually towing the backbone beam dolly or towing it with a lightweight vehicle.

### BACKGROUND OF THE INVENTION

Material-handling devices that are powered-units capable of loading and unloading freight from a truck have been utilized for years. The backbone beam dolly is much more cost-effective and can travel with the truck over vast distances without substantially increasing the weight of the loaded truck.

### SUMMARY OF THE INVENTION

I have discovered that a beam can be constructed in a manner which makes it possible to add or remove interchangeable wheel assemblies, outriggers and lifting cranes. This makes it possible to utilize a backbone beam unit that has a very high strength-to-weight ratio to load and unload large loads from a truck without the use of an expensive separately powered lifting crane.

The backbone beam dolly is towable by one man. A pallet jack may be used at one end in place of a wheel assembly. The dolly with an outrigger can pick-up large loads and transport them over significant distances.

The backbone beam dolly provides a highly cost effective material-handling device which can be carried in a truck. Since the backbone beam dolly is a very lightweight device it does not greatly reduce the payload capacity of the truck.

The specific nature of the invention, as well as other objects, uses, and advantages, thereof, will clearly appear from the following description and from the accompanying drawings. Drawings are not to the same scale.

### BRIEF DESCRIPTION OF DRAWINGS

FIG. 1 Elevation view of the backbone beam dolly.

FIG. 2 Sectional view of the backbone beam dolly longitudinal centerline.

FIG. 3 Front view of narrow wheel base wheel assembly with swivel casters.

FIG. 4 Front view of wide wheel base wheel assembly non-swivel casters.

FIG. 5 Perspective view of four-wheeler dolly with receiver for coupling mechanism for single and dual unit coupling.

FIG. 6 Front view of single four-wheeler dolly unit coupling mechanism.

FIG. 7 Front view of dual unit coupling mechanism.

FIG. 8 Perspective view of backbone beam dolly with two units of four-wheeler dollies providing the wheel assembly support for one end.

FIG. 9 Perspective view of the backbone beam dolly with outrigger and lifting arm.

FIG. 10 Side view of backbone beam dolly with pallet jack in front of wheel assembly position.

FIG. 11 Pallet jack coupler.

FIG. 12 Crane beam assembly.

FIG. 13 End view of female receiver of crane beam.

FIG. 14 Top view of crane beam.

FIG. 15 Ground engaging feet.

FIG. 16 Side view backbone beam dolly being hoisted up by ratchet attached to truck.

FIG. 17 Side view landing gear jack being cranked down to stabilize the backbone beam dolly.

FIG. 18 Cut away view. Backbone beam dolly held in place under truck bed. Ground engaging feet hold both ends of dolly.

### DESCRIPTION OF THE PREFERRED EMBODIMENT

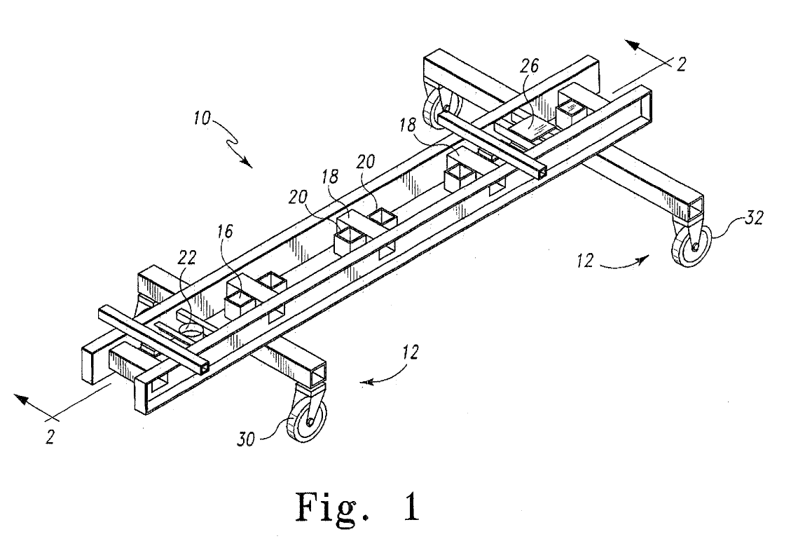

Backbone beam dolly material-handling device 10 is shown in FIG. 1. The horizontal disposed frame comprises longitudinal frame members 11, cross members 18, and wheel assemblies 12. In the preferred embodiment, the longitudinal frame members and cross members are rigid structures of steel or aluminum. The longitudinal member is a channel shape structure with holes which allow cross members 18 to project through and be welded. The cross members are hollow tubes that form tunnels through which straps can pass to secure the load.

The backbone beam dolly is a multipurpose material-handling device 10 which receives interchangeable wheel assemblies 12. Wheel assemblies 12 are within the structure male insert 16 that fits into receiver 20 and is kept in place by means of a coupling pin. The backbone beam dolly 10 works extremely well with a wheel assembly 12 that contains a pair of swivel casters 30 and another wheel assembly with a pair of non-swivel casters 32. The backbone beam dolly can be pulled manually or towed with a lightweight vehicle.

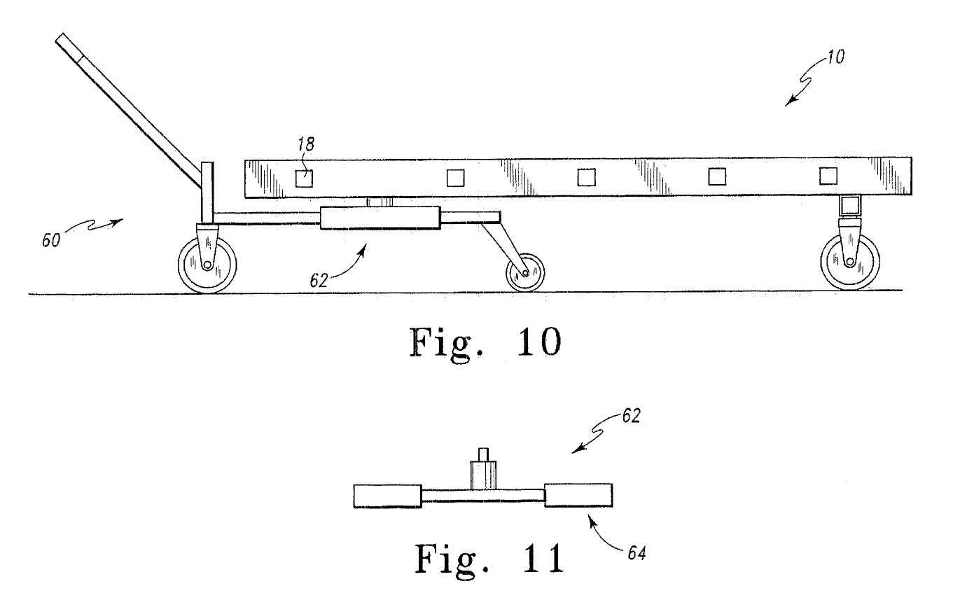

Another version of usage of the backbone beam dolly is configured when the wheel assembly 12 or 14 is replaced with a pallet jack coupler 62 and a pallet jack 60 is put into place as shown in FIG. 10. The pallet jack 60 can be used to tow the backbone beam dolly 10. Either a manual or an electrically powered pallet jack can be used. The pallet jack coupler 62 is inserted and secured into pallet jack coupler receiver 22. The pallet jack coupler 62 can rotationally swivel about the vertical axis extending through a longitudinal centerline of the backbone beam dolly. By using a pallet jack in conjunction with the backbone beam dolly, the combination of the dolly and the load can be stopped by lowering the pallet jack 60 and allowing the pallet jack coupler 62 to engage the ground. A load much longer and heavier can be transported with a pallet jack and backbone beam dolly combination than would be possible by using the pallet jack as a single unit.

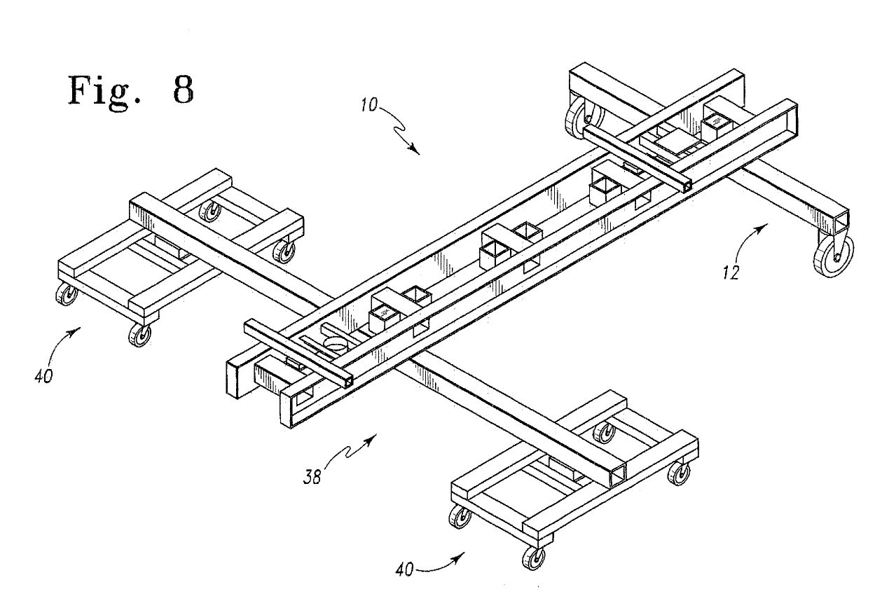

Two four-wheeler dollies can be mated to the front end of a backbone beam dolly using a dual four-wheeler dolly coupler 38 shown in FIG. 7. This dual unit configuration is shown in FIG. 8. The wide spacing of the four-wheeler dollies provided by coupler 38 gives good protection against a load with a high center of gravity falling over.

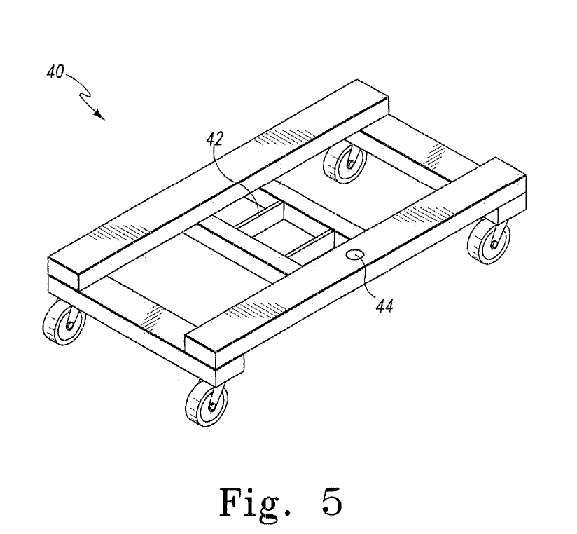

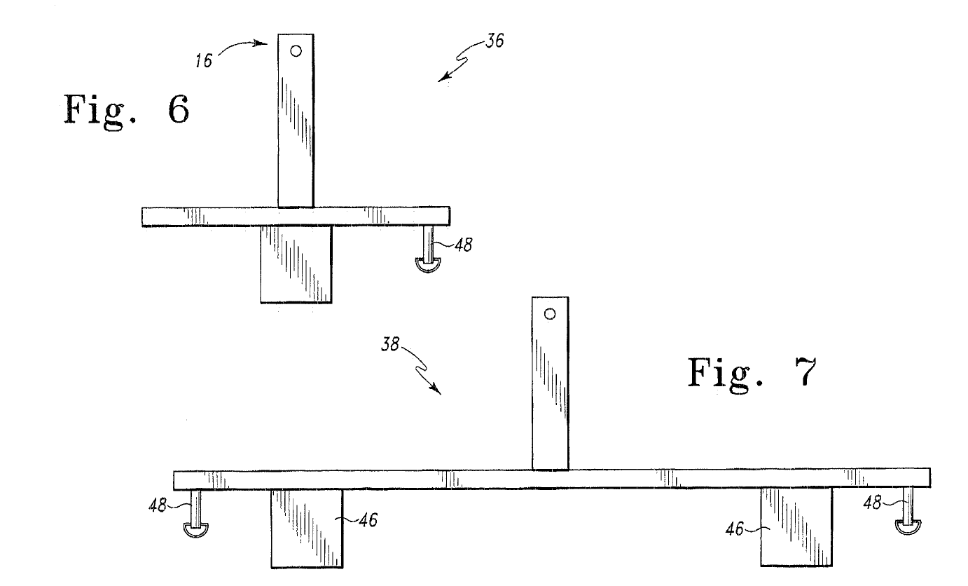

Another useful version of configuring the backbone beam dolly is to replace wheel assembly 12 with one four-wheel dolly 40. The single four-wheeler coupler 36 shown in FIG. 6 can be rigidly attached to the four-wheeler dolly 40 shown in FIG. 5. This is done by inserting male element 46 into receiver 42 and simultaneously inserting pin element 48 into hole 44 of the four-wheeler dolly and using a lynch pin to secure the configuration. This version of the backbone beam dolly works well where space is limited. The backbone beam can be carried without the need for wheel assemblies. The four-wheeler dollies are available to work as solo units when not in use as part of a backbone beam dolly configuration.

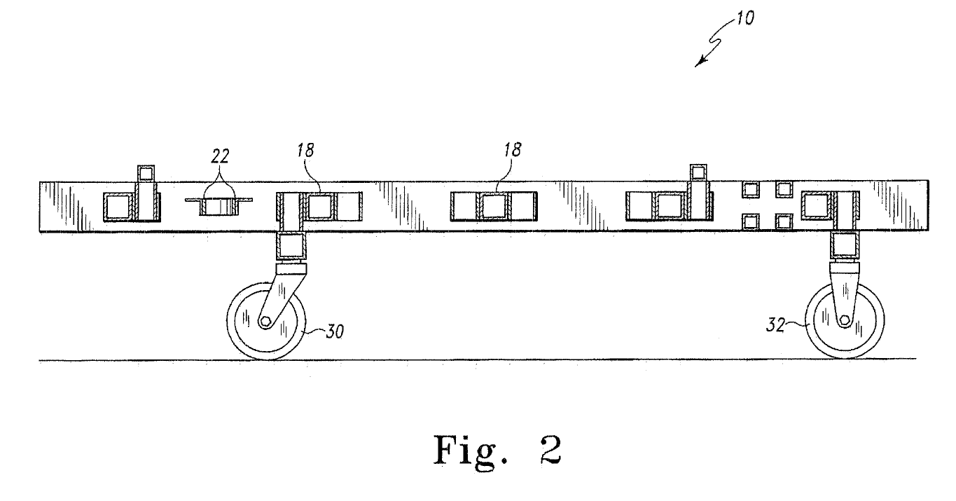

FIG. 2 shows a sectional view of the backbone beam dolly with two wheel assemblies.

One of the wheel assemblies 12 has swivel casters 30 and the other wheel assembly has non-swivel casters 32.

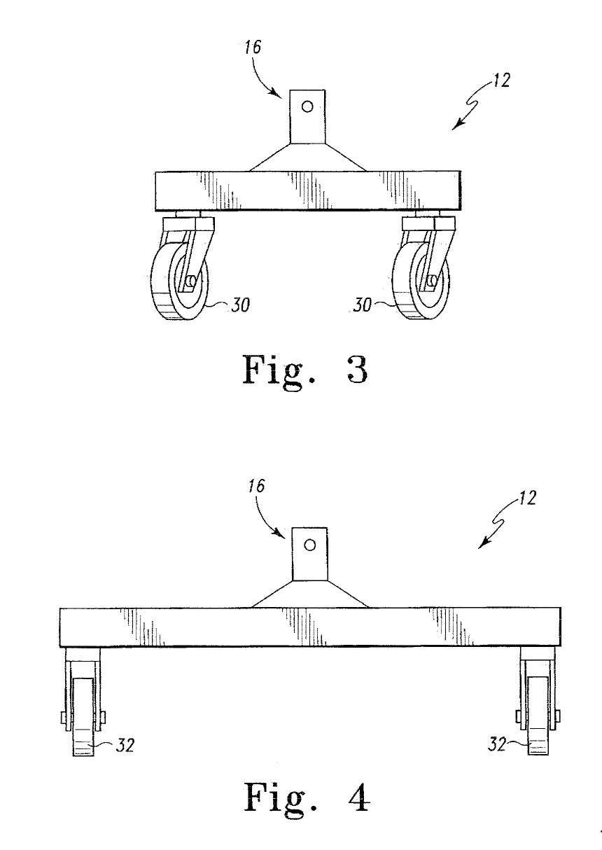

FIG. 3 shows a narrow wheel base wheel assembly with swivel casters 30. FIG. 4 shows a wide wheel base wheel assembly with non-swivel casters 32.

FIG. 5 shows a four-wheel horizontally disposed dolly 40 with a receiver 42. FIG. 6 shows a single four-wheeler dolly coupling unit 36 and FIG. 7 shows a dual four-wheeler dolly coupling unit 38.

The dual dolly coupling unit 38 is shown affixed to the backbone beam dolly 10 in FIG. 8. This arrangement of using two four-wheeler dollies provides a wide wheel base and makes it possible to transport loads with a center of gravity which is a significant distance from the longitudinal axis of the backbone beam dolly.

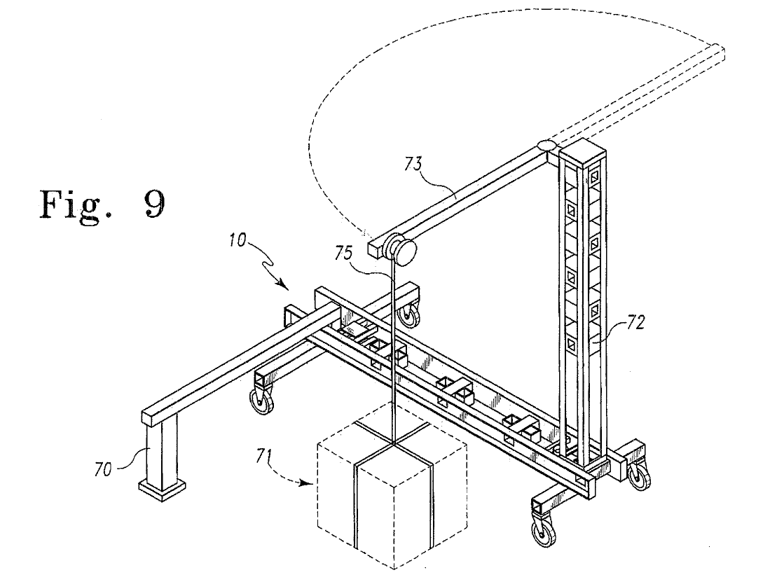

FIG. 9 shows a backbone beam dolly 10 with a crane 72 inserted at the other end. The end of the backbone beam dolly opposite the crane has an outrigger arm 70. This arrangement makes it possible to pick up the load 71 using a hoist 75 extended from rotationally hinged arm 73.

FIG. 10 shows a backbone beam dolly 10 fitted with a pallet jack coupler 62. This allows the pallet jack 60 to be used to lift the backbone beam dolly and transport loads.

FIG. 11 shows a pallet jack coupler 62 with pallet jack fork receiver.

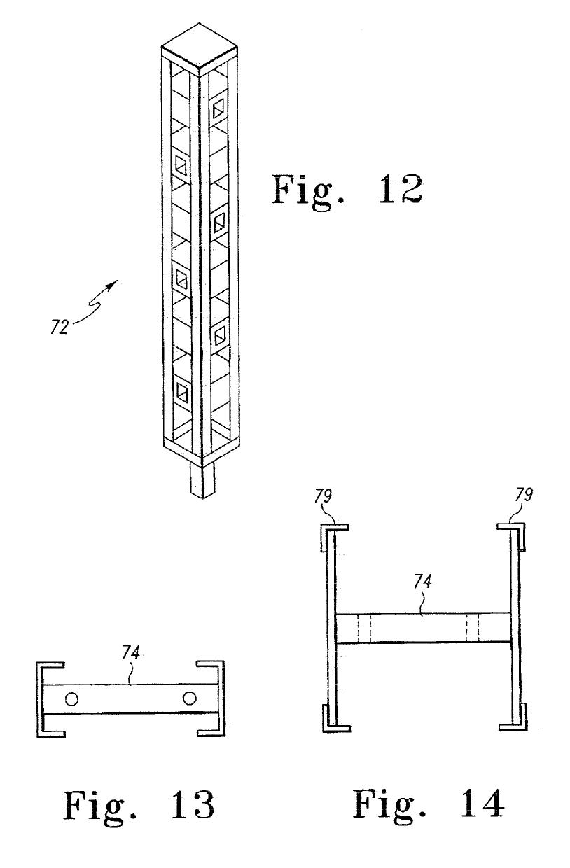

FIG. 12 shows the construction of the crane assembly 72. Cross member tubes 74 are welded to cross member elements 52.

FIGS. 13 and 14 show the cross members 74 that go into the crane beam assembly 72.

FIG. 14 shows the placement of the corners on 78.

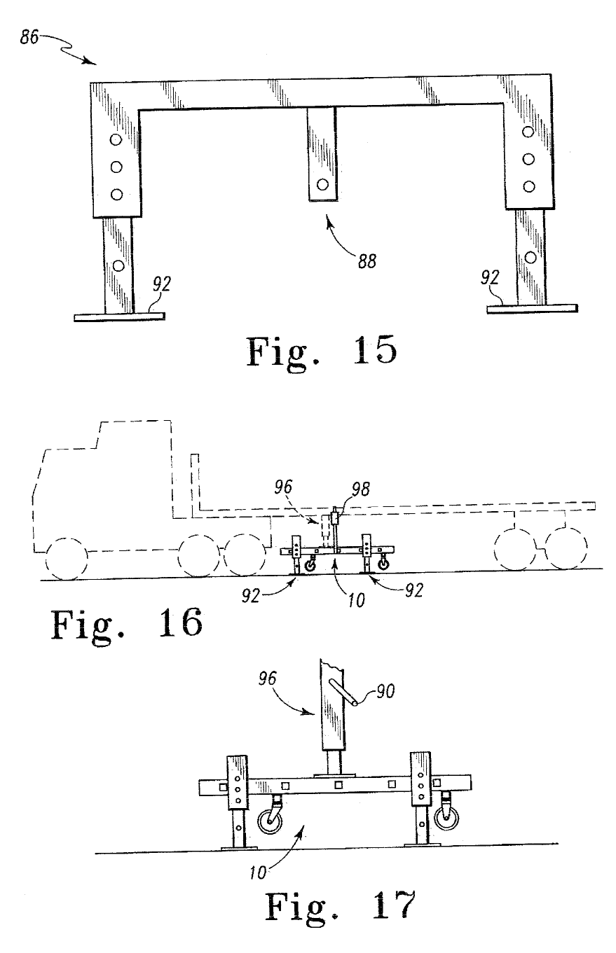

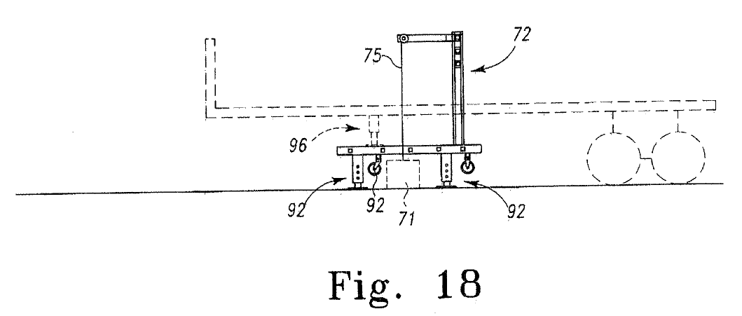

FIG. 16 shows a truck 94 with an extendable trailer landing gear 96. The backbone beam dolly is fitted with ground engaging feet mechanisms 86 shown in FIG. 15. Adjustable ground engaging feet 92 extend from the unit and engage the ground. The ratchet strap assembly number 98 shown in FIG. 17 is used to hoist the wheel assembly 12 until it is well clear of the ground. The ground engaging feet 92 are extended and tension on the ratchet strap assembly is removed. Cranking handle 90 is used to extend the trailer landing gear leg. 96. The weight of the truck 96 is applied to the backbone.

FIG. 18 shows the backbone beam dolly with ground engaging feet. The backbone beam dolly is stabilized by vertical downward force from the trailer landing gear dolly 96. A crane assembly is in place to load freight onto or unload freight from the bed of the truck.

As an aid to correlating the terms of the claims to the exemplary drawing, the following catalog of elements is provided:

10 Backbone beam dolly

11 Frame members

12 Wheel assembly

14 Wide spread wheel assembly

16 Male insert

18 Cross members

20 Receivers

22 Pallet jack coupler receiver

24 Load carrier unit

30 Swivel casters

32 Non-swivel casters

36 Single four-wheeler coupler

38 Dual dolly coupler

40 Four-wheeler dolly

42 Receiver for coupling unit

44 Coupling hole

48 Pin element

52 Cross member elements

60 Palletjack

62 Pallet jack coupler

64 Pallet jack fork receiver

70 Outrigger arm

71 Load

72 Crane assembly

73 Rotationally hinged arm

74 Cross member tubes

75 Hoist

76 Crane beam insert

78 Longitudinal corner units

84 Hoisting arms

85 Ground engaging feet mechanisms

88 Male insert

90 Cranking handle

92 Adjustable ground engaging feet

94 Trailer

96 Extendable trailer landing gear

98 Ratchet strap

The embodiment shown and described above is only exemplary. I do not claim to invented all the parts, elements or steps described. Various modifications can be made in the construction, material, arrangement, and operation, and still be within the scope of my invention. The limits of the invention and the bounds of the patent protection are measured by and defined in the following claims. The restrictive description and drawing of the specific example above do not point out what an infringement of this patent would be, but are to enable the reader to make and use the invention as follows:

The invention is therefore claimed as follows:

1. A material-handling unit with a frame which comprises a horizontally disposed structure with a plurality of longitudinal members, a plurality of cross-frame members, and a plurality of receivers where said receivers can quickly receive and rigidly affix
A. Wheel assemblies
B. Outriggers
C. Receiver for a pallet jack
D. A crane beam assembly
E. Load carriers.

2. The frame of claim 1 wherein said cross members consist of a tubular structure and are extended through said longitudinal members thus providing a tunnel through which straps and similar objects may pass and then secure the load.

3. A method of securing a load to the material-handling unit frame of claim 2 where the method comprises the steps of
A. Running a strap or straps through the tubular cross members
B. Placing a load onto the material-handling unit frame
C. Securing the load to the frame with the strap by wrapping or tying the load and tightening the strap.

4. The material-handling unit of claim 1 with the additional limitation that the cross-frame members are composed of square or rectangular structural tubing.

5. A crane beam assembly which is constructed with a plurality of corner members running parallel to the central longitudinal axis of said crane beam assembly and the corner members are attached to cross-member spacers that have therein at least one female receiver and are capable of receiving
A. Lifting crane beam
B. Coupling mechanism
C. An outrigger assembly
and said crane beam assembly has a male insert to be fitted in to and rigidly attached to the horizontally disposed structure of claim 1.

6. The crane beam assembly of claim 5 with the additional limitation that the crane beam is affixed to the horizontally disposed backbone beam dolly of claim 1 in a substantially perpendicular orientation to the longitudinal axis of the backbone beam dolly.

7. A horizontally disposed dolly with at least 2 pairs of wheels and a removable mechanism that extends vertically above the dolly and makes it possible to rigidly affix said horizontally disposed dolly to the backbone beam dolly of claim 1.

8. A pallet jack receiver which can be affixed to a receiver of said backbone beam dolly of claim 1 where said receiver is capable of receiving the forks of the pallet jack and allowing the receiver to swivel so that the pallet jack can lift one end and move the backbone beam dolly along any desired path and across significant distances.

9. A method of moving freight with a combination of the backbone beam dolly of claim 1 and a pallet jack wherein said method comprises the steps as follows:
A. Affix the backbone beam dolly of claim 1 with a wheel assembly with a plurality of wheels near one end and with a pallet jack receiver near the other end
B. Place and secure the load onto the back bone beam dolly equipped with load receivers
C. Insert the pallet jack forks into the pallet jack receiver
D. Use the pallet jack to lift the backbone beam dolly and the load
E. Move the combination of the load, the backbone beam dolly and the pallet jack along a desired path to the location desired
F. Remove load.

10. The method of moving freight as described in claim 9 with the additional steps of:
A. Rigidly affix an outrigger in a direction which is close to perpendicular to the longitudinal axis of the backbone beam dolly
B. Rigidly affix a rotationally moveable arm to the backbone beam dolly
C. Attach a hoisting mechanism to the rotationally moveable arm
D. Use the rotationally moveable arm with hoisting mechanism attached to load and remove loads from and onto the backbone beam dolly.

11. A method of constructing a wheel assembly to be used with backbone beam dolly of claim 1, wherein said method comprises the steps of:
A. Rigidly affixing two four-wheelers horizontally disposed dollies to a dual dolly mechanism
B. Rigidly affixing the dual dolly-coupling unit described in Step A, to the backbone beam dolly.

12. A rigid mechanical frame which is capable of having the lower portion rigidly attached to the frames of a plurality of four-wheeler dollies and the upper portion of said mechanical frame rigidly attached to the backbone beam dolly of claim 1, wherein said rigid mechanical frame and four-wheeler dollies function as a wheel assembly.

13. The backbone beam dolly of claim 1 fitted with an outrigger on one end and the crane beam assembly of claim 5 fitted with a horizontal arm rotationally hinged at the end affixed to said crane, where said lifting arm is capable of moving in a horizontal plane and a hoisting mechanism attached at the movable end, wherein such combination of units is capable of lifting a load positioned near the backbone beam dolly with the hoist and moving the horizontal arm so the load is positioned over the backbone beam dolly and may be lowered onto the backbone beam dolly for transport.

14. The crane beam assembly of claim 5 with the additional limitation of the female receivers are constructed of rectangular or square tube.

15. A ground engaging foot mechanism with an insert that is capable of rigid attachment to the backbone beam dolly and a plurality of adjustable ground engaging feet.

16. A method of hoisting freight onto a truck or other vehicle equipped with a landing gear dolly wherein said method comprises the steps as follows:
A. Affix the backbone beam dolly of claim 1 with at least one ground engaging foot mechanism
B. Position the backbone beam dolly underneath the landing gear dolly
C. Hoist the backbone beam dolly with a hoisting mechanism with one end attached to the truck and the other end attached to the backbone beam dolly until a wheel assembly is well clear of the ground
D. Extend and pin the ground engaging feet
E. Relax tension on the hoist
F. Extend the landing gear dolly from the vehicle downward until the backbone beam is solidly held in place by force from the landing gear dolly and a recipical force from the ground engaging feet
G. Use the crane beam assembly of claim 5 with a lifting crane beam to load and unload freight onto and from the vehicle bed.
